(19) United States
(12) Patent Application Publication
(10) Pub. No.: US 2004/0119184 A1
(43) Pub. Date: Jun. 24, 2004

(54) Method for foaming in place headliner structures

(75) Inventors: Bari William Brown, Ann Arbor, MI (US); George Bernard Byma, Clarkston, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI

(21) Appl. No.: 10/327,823

(22) Filed: Dec. 23, 2002

(51) Int. Cl. B29C 44/14

(52) U.S. Cl. 264/46.4

(57) ABSTRACT

A method for forming a headliner assembly includes forming a main body blank having a periphery in a shape corresponding to a desired shape of the headliner assembly. A mold has a lower mold part with a correspondingly shaped surface with a recess. The method includes pouring foam into the recess in an open mold, then closing the mold to join the foam to the main body. The recess or the main body can carry an accessory, and the foam may surround the accessory. Preferably, a pouring robot serves a plurality of mold parts so that curing time and mold assembly time do not prolong the production of foam enhanced headliners.

### BACKGROUND OF THE INVENTION

1. Field of the Invention

The invention relates to a method for forming headliners by pouring foam in open mold part recesses and joining the foam structures to shaped substrates.

2. Background Art

The covering of the interior surface of a vehicle roof panel is known as a headliner, and may be made and installed in numerous ways. One prior method of making a headliner assembly placed energy absorbing foam pads in the headliner. The pad forming process included molding a block of foam, slicing the block into panels, die-cutting the panels, and compression molding the panels to form the pads. The pads are then attached to a preformed headliner body using assembly dies and an adhesive. Because of the multiple steps involved with forming the pads and attaching the pads to the headliner, this method is time consuming, labor intensive and costly, and also results in significant material waste.

U.S. Pat. No. 5,845,458 discloses another method of making a headliner having deformable foam inserts disposed on side edges of the headliner. The method includes positioning a cover layer, a foam panel, and preformed foam inserts in a mold, and draping a flexible backing layer over the foam panel and foam inserts. Suitable adhesives are also positioned between the cover layer and the foam panel, and between the foam panel and the foam inserts. The mold is then closed to compression mold the foam panel and foam inserts, as well as to stiffen the backing layer. However, this method also involves multiple steps for forming the inserts and attaching the inserts to the remainder of the headliner, complicating and increasing the expense of headliner production.

Another known process applies foam in place technology to provide energy absorbing pads at likely contact areas adjacent to impactable structures, such as roof panel edges. The known method for forming this headliner assembly includes injecting foam in recesses in closed mold parts to form an energy absorbing member at the likely contact areas and joining the energy absorbing member to a main body of the headliner assembly proximate to the periphery of the body. While the method significantly reduces time and manufacturing costs compared with prior methods for locating and attaching energy absorbing foam pads proximate the periphery of headliners, the method complicates the headliner structure, and the handling during production and installation because of the localized pads. This process has also been used to form structural beams on the headliner to reinforce the headliner and reduce flexing during handling and reduce the difficulty of installing the headliner. However, the fluid injecting heads are coupled to each mold part, and not readily applied to multiple mold without substantial labor and down time after curing the parts in the closed mold.

### SUMMARY OF THE INVENTION

The present invention overcomes the above disadvantages by providing a method for forming a headliner assembly or other internal finish panel by pouring foam in an open mold part and by joining the foam with a main body or substrate in a closed mold. According to one embodiment of the invention, a method for forming a headliner assembly includes forming at least one recess in a mold part, filling the recess with foam and inserting a main body blank corresponding to a desired shape of the headliner assembly between the mold parts. The process includes closing the mold to join the beam and any components positioned in the recess or aligned with the recess and attached to the main body, as part of the headliner embedded in the foam beam.

In the process, at least one mobile pour head is used to pour foam forming fluid into recesses in the mold part. The head may have one or more nozzles depending upon the compositions of foam to be introduced to the mold. The pour head may be carried by a manual or automated mobile support, preferably a robotic arm, that introduces or displaces the head to the open mold. The open mold may also be accessed by more than one robotic arm or pour head as desired.

The beam may be formed across any dimension of the main body. By using a mold having multiple recesses, a headliner assembly may be formed with multiple beams. Similarly, if the recesses are joined in fluid communication, the beams may be joined to form a frame over a substantial area of the vehicle roof. According to another embodiment of the invention, foam may be poured into one or more recesses, and the foams may have different densities and/or chemistries. Alternatively, the mold in place operation may involve multiple pour heads or robots for introducing foam into the recesses of a lower mold part.

Regardless of how the foam is introduced to the recess or recesses in the mold parts, the foam beam may support accessories at the headliner. Moreover, the foam may be shaped by the recesses to form pads located as desired, for example, between beams or within framed areas, with foams of desired densities. The foams may provide important protection or support for accessories. Similarly, wiring may be secured by the foam in predetermined positions, while headliner areas, for example, areas intermediate beams, or enclosed by a frame of beams may be provided with molded pads of acoustically damping foam or other foam chemistries that reduce or enhance acoustic energy.

### BRIEF DESCRIPTION OF THE DRAWINGS

The present invention will be better understood by reference to the following detailed description of a preferred embodiment when read in conjunction with the accompanying drawing, in which like reference characters refer to like parts throughout the views, and in which:

FIG. 1 is a sectional, perspective view of a headliner assembly according to the present invention;

FIG. 2 is an enlarged fragmentary sectional view of the headliner assembly of FIG. 1;

FIG. 3 is a schematic view of a production line arrangement for manufacturing the headliner assembly;

FIG. 4 is a cross-sectional view of a blank used to manufacture the headliner assembly, wherein the blank is supported by a frame;

FIG. 5 is a top view of a headliner assembly showing modified beam structure according to the present invention;

FIG. 6 is a perspective view of the open mold having recesses for forming the foam beams shown on the headliner of FIG. 5; and

FIG. 7 is a sectional view taken substantially along the line 7-7 in FIG. 6.

### DETAILED DESCRIPTION OF THE PREFERRED EMBODIMENT

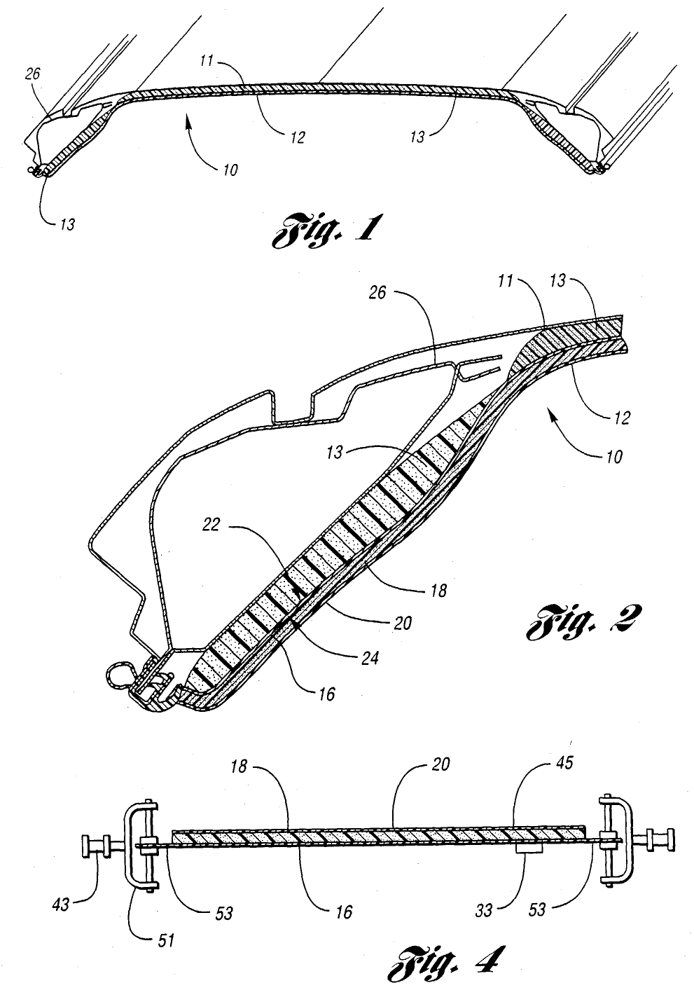

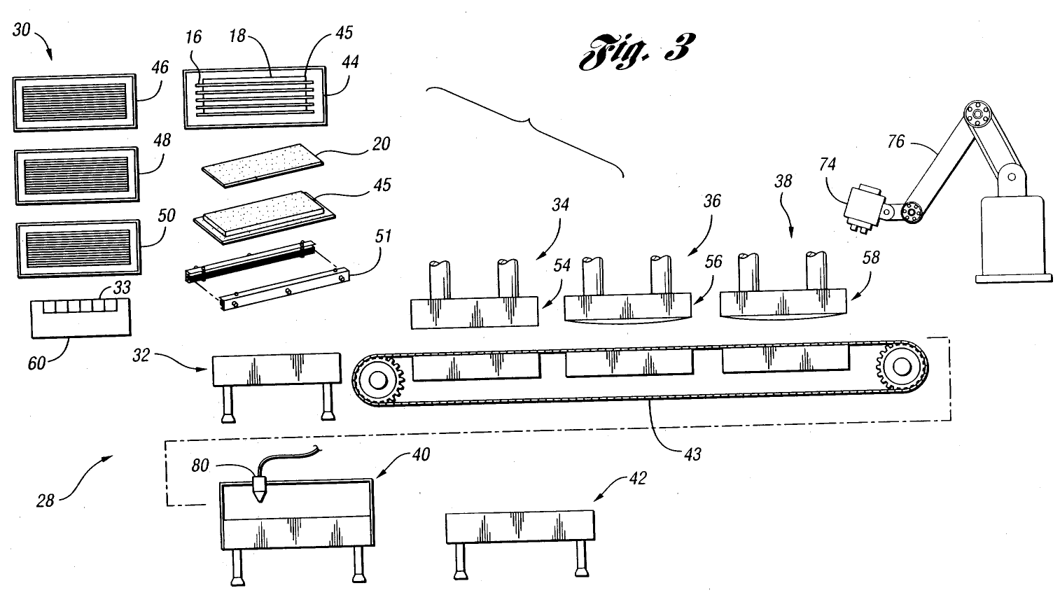

Referring first to FIGS. 1 and 2, a headliner assembly 10 according to the invention is adapted to be mounted to a roof 11 of a motor vehicle. The headliner assembly 10 includes a main body 12 that supports or is reinforced by at least one foam beam. In the preferred embodiment, a forward beam 13, a mid beam 14 (FIG. 5), a rear beam 15 (FIG. 5) and longitudinal beams 17 and 19 (FIG. 5) are formed on and joined to the main body 12 near the periphery of the main body 12. The main body 12 has a first or backing layer 16, a second or substrate layer 18 and a cover layer 20. The backing layer 16 is preferably a relatively stiff, semi-flexible scrim layer, and has a first or upper surface 22 that is positioned proximate the interior surface of the roof 11 of the vehicle and a second or lower surface 24. The substrate layer 18 is attached to the lower surface 24 of the backing layer 16, such as with an adhesive. Nevertheless, changes in the structure forming the substrate 18 and backing layer 16 are also within the scope of the present invention.

While the main body 12 and the substrate layer 18 may comprise any suitable material, in the preferred embodiment illustrated, the substrate layer 18 preferably comprises a thermoformable rigid urethane layer sandwiched between two fiberglass layers. The cover layer 20 may be any suitable cover material, such as cloth, vinyl or foam backed leather, and provided with or without a padding layer depending upon the use characteristics required. The cover layer 20 is attached to the substrate layer 18, preferably with an adhesive. Alternatively, the headliner assembly 12 may be manufactured without a backing layer 16 and/or a cover layer 20 if not required for a particular application.

The front beam 13, mid beam 14, rear beam 15 and side beams 17 and 19 may be disposed proximate or inwardly of peripheral portions of the roof 11 when the headliner assembly 10 is mounted to the roof 11. For example, as shown in FIGS. 1, 2 and 5, the beams 17 and 19 are disposed proximate side rails 26 of the roof 11 when the headliner assembly 10 is mounted to the roof 11, such that the beams are positioned interiorly of the side rails 26. The number of beams, and the size and shape of each beam may be varied depending on the application.

The beams 13, 14 and 15 are made of a foam that may be energy absorptive but other compositions are also within the scope of the present invention. While the foam may comprise any suitable material, in a preferred embodiment illustrated, the foam comprises a mixture of isocyanate and resin, which is polyurethane commercially available from several sources. Advantageously, the beams 13, 14, 15, 17 and 19 are molded directly onto the backing layer 16 such that the beams are simultaneously formed and joined to the backing layer 16 in a single operation, which is described below in greater detail. Alternatively, the beams may be molded directly onto the substrate layer 18 if the backing layer 16 is eliminated.

In the preferred embodiment, the beams 13, 14, and 15 are joined by forming in one piece with the side beams 17 and 19. Such an arrangement forms a frame 25. Nevertheless, it is to be understood that beams according to the invention as described in detail below, can be formed individually without joining other beams, as desired, without departing from the scope and spirit of the present invention. In any event, beams may be formed to include a selected area surrounded by the foam forming the beam as discussed below.

FIG. 3 shows a production line arrangement 28 according to the invention for forming the headliner assembly 10. The production-line arrangement 28 includes a component storage area 30, a loading station 32, a heating station 34, a forming station 36, a foam-in-place molding station 38, a cutting station 40, and a fixture installation station 42. The production-line arrangement 28 further includes a conveyor system 43, such as a chain conveyor, for transporting components between the stations. The stations may be rearranged in the line as desired, for example, where the cutting station 40 may trim the substrate before a molding station 38 acts upon the substrate 18.

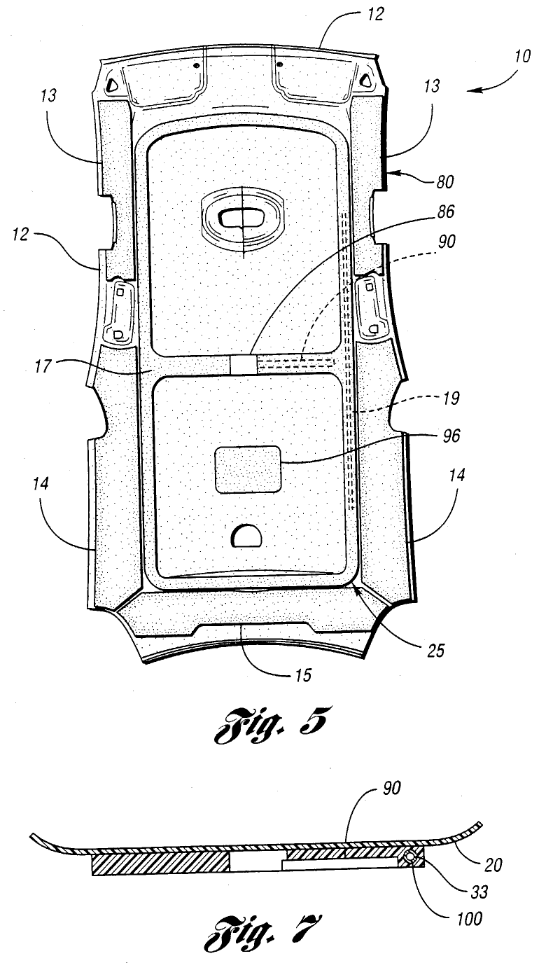

In the preferred production line arrangement 28, the component storage area 30 preferably includes a source 44 of blanks 45, wherein each blank 45 comprises a substrate layer 18 with a backing layer 16 attached thereto. The component storage area 30 further includes a plurality of sources 46, 48 and 50 of cover layers, wherein each cover layer source 46, 48 and 50 contains cover layers that are different in color and/or composition compared with another of the cover layer sources 46, 48 and 50. At loading station 32, a blank 45 and a particular cover layer 20 selected from one of the cover layer sources 46, 48 and 50 are positioned in a transport frame 51 (FIG. 4). The frame 51 is then mounted on the conveyor system 43. An adhesive layer may also be positioned between the blank 45 and the cover layer 20 at station 32.

On the other side 16 of the main body or blank 45, components such as a cable or conductor 33 (FIG. 4), from a supply 60 (FIG. 3) may be attached at a predetermined position. For example, a connecting cable 33 to an electronic accessory may be adhered to the backing layer 16 at a position predetermined to be aligned with a mold recess as discussed below.

As shown in FIG. 4, the backing layer 16 of the blank 45 of the preferred embodiment preferably has an extended portion 53 that extends beyond the substrate layer 18 of the blank 45. Preferably, the transport frame 51 grips the extended portion 53 to thereby support the blank 45 and the cover layer 20 on the conveyor system 43. As another example, a conveyor system may be provided with upper and lower chains that grip the extended portion 53 therebetween for delivery to a mold. The substrate layer 18 of the blank 45 may be appropriately sized to closely match the final size or outline of the headliner assembly 10, to thereby reduce scrap or waste material. Of course, other transports may be used without departing from the invention. For example, the blank 45 and the cover layer 20 may be transferred by robotic arms to the heating station 34 shown in FIG. 4.

The heating station 34 includes a platen assembly 54 having upper and lower heated platens that engage the blank 45 and the cover layer 20 to thereby heat the blank 45 and the cover layer 20. Preferably, the platen assembly 54 also has a plurality of thermocouples for sensing temperature of the blank 45 and the cover layer 20. Once sufficiently heated, the blank 45 and the cover layer 20 are transferred by the conveyor system 43 to the forming station 36.

The forming station 36 includes a first mold 56 having first and second mold portions for thermoforming the blank 45 and the cover layer 20 to form the main body 12, such that the main body 12 has a shape that corresponds to a desired shape of the headliner assembly 10. Preferably, both mold portions may also be chilled in any suitable manner, such as by circulating chilled fluid, such as water through the mold portions. The forming station 36 preferably includes multiple molds, similar to the first mold 56, that can be alternately used to form different headliner shapes and sizes. The main body 12 is then transported manually or otherwise to the foam molding station 38.

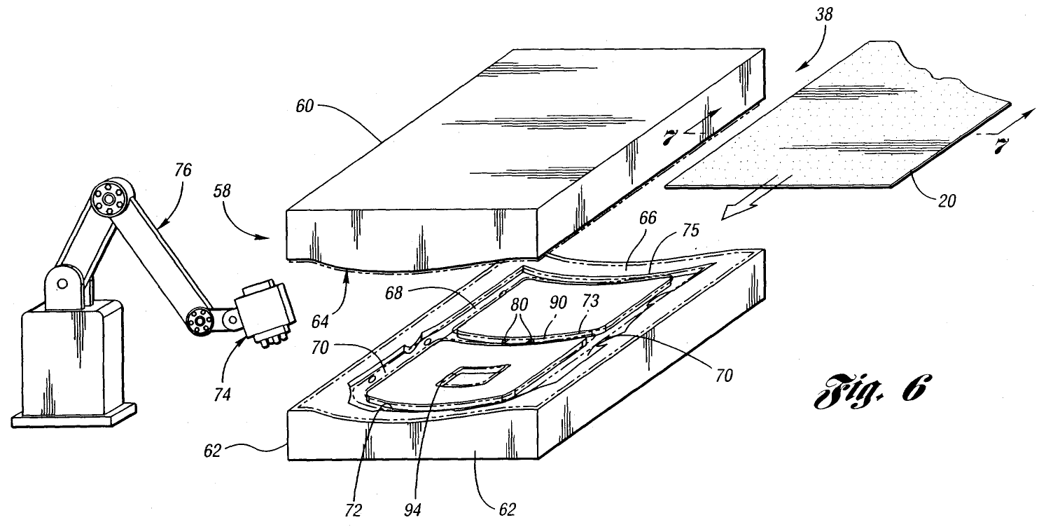

The foam molding station 38 includes a second mold 58 for forming the foam beams on the main body 12, to thereby form the headliner assembly 10. The foam in place molding station 38 preferably includes multiple molds similar to the second mold 58 for forming various beam configurations on various headliner configurations as will be described below. As shown in FIG. 6, the mold 58 includes a first or upper mold portion 60, and a second or lower mold portion 62. The upper mold portion 60 has a mold surface 64 that corresponds with the formed shape of the cover layer 20, or the formed shape of a surface of the main body 12 to which the cover layer 20 is attached. The lower mold portion 62 has a mold surface 66 that corresponds with the formed shape of the backing layer 16 of the main body 12.

The lower mold portion 62 includes a plurality of cavities or recesses 68, 70, 72, 73 and 75 for respectively forming the beams 13, 14, 15, 17 and 19. Each of the recesses may be filled by one or more pour heads 74 that are carried by a mobile support such as a robotic arm 76. The support provides movement of the head to recesses 68, 70, 72, 73 and 75 particularly if the recesses are separated from each other. Each of a plurality of robot arms 76 may also position pour heads 74. In the embodiment shown, where all recesses 68-75 are in fluid communication with each other, a single nozzle or pour head 74 may introduce the foam into the recesses as the robotic arm 76 moves in a path along the recesses. Nevertheless, multiple pour heads 74 and robotic arms 76 may be used to expedite the introduction of foam to the mold 58. The pour heads 74 are connected to one or more sources of foam (not shown), such as a mixture of isocyanate and resin.

At molding station 38, the formed main body 12 is positioned between the mold portions 60 and 62. Preferably, the main body is positioned over the lower mold part 62 by aligning with respect to the upper mold part 60 and maintaining the alignment with clamps, guides or the like. Preferably, the position may occur before the pouring step to avoid prolonged delay, for example, for moving the blank, robots, and mold parts, before closing the mold parts and completing curing of the foam after the recesses have been filled but before the foam has set or cured. The mold portions 60 and 62 are closed together. Because foam introduced into the larger recesses may require more time to expand and cure than foam poured into the smaller recesses, the flow rate of foam into the recesses may vary along the path, and multiple nozzles may be made available. As a result, expansion and curing of the foam may be arranged to conclude in all of the recesses at approximately the same time. The lower mold portion 62 may also be heated, preferably, in the range of 130° F. to 190° F. for isocyanate and resin, to assist in the expansion and curing process of the foam, and to flash off water that may be associated with a mold-release agent applied to the mold parts such as sprayed on wax for an injection molding operation. The multiple pour heads 74 feeding a particular one of the larger recesses may preferably pour foam simultaneously, or in closely spaced stages, so as to provide relatively consistent foam characteristics throughout.

Because the recesses 68, 70, 72, 73 and 75 or others may be separated from each other, the quantity, direction, rate of displacement along the paths, or the mass of foam per unit of recess volume delivered by the pour heads 74, which is referred to as introduction density of the pour heads 74, can be varied from one to another of the recesses so as to vary the cure rate of the resultant beams. Consequently, foam density can be increased in areas requiring greater strength, such as areas of the headliner assembly 10 that will be remote from a side rail or remote from roof supporting A-pillar joints of a motor vehicle. Furthermore, foam densities can be decreased in areas requiring less strength so that overall material costs can be significantly reduced. Different foam compositions may also be used under the method according to the invention to form beams having different features or densities.

The headliner assembly 10 may be precisely formed to achieve relatively close design tolerances with significantly fewer steps and assembly procedures. Because beams are not individually handled and stored, this method involves lower inventory, lower assembly costs and part handling costs compared with prior methods that separately form and install separate support structures and beams. Preferably, before the pouring begins, a mold release layer, for example, a polyethylene, polystyrene or other urethane sheet, may be laid over the surface of the lower mold part.

Moreover, components such as wiring harnesses, preformed foam components such as head impact energy absorbing pads, for example, pads meeting code standards such as FMVSS 201.u, foam cushions, or other accessories, may also be mounted to the headliner in the pour in place process at the molding station 38. Components to be installed in the headliner may be positioned within the recesses in the cavity or shaped surface 66 of the female mold part 62, for embedding the component partially or completely in the beams formed in the mold. For example, as shown at 90, a wiring harness may be positioned in a predetermined location, preferably guided by alignment devices, for example, pins 80 or other position locators, with respect to functional components to be installed after construction of the headliner. For example, the wiring harness 90 as shown in FIG. 5, extends into a component area for coupling to a component so that any component installed above or carried by the headliner may be provided with electrical power through the harness 90. Of course, the other end of the harness 90 is positioned for easy access to a power source or other coupling or connector in the electrical system, and may be made accessible to sources, coupling components or the like by cutting of the headliner assembly after the molding operation, for example, at cutting station 40 discussed below.

Nevertheless, the method of constructing the foam beams also serves to embed and mount accessory components such as a cable conductor 33, energy absorbing members or other vehicle accessory components introduced to the molding station 38 by other means, for example, adhered to the blank as shown in FIGS. 3 and 7. Another example is shown at 100 where a plastic tube, for use as a rear window washer conduit, can be embedded in the foam. When the embedded component includes an end piece such as a coupler, the mold 58 may include a dedicated cavity, that may not be a foam receiving recess, that receives the coupling and protects it when the mold is closed. Other energy absorbing members include high energy absorbing members, such as HEXCEL™ honeycomb bodies or metal tab structures discussed in U.S. patent application Ser. No. 09/927,154 owned by the assignee of the present application.

In addition, a separate foam pad, such as overhead acoustic pad 96, may be added on the back of the headliner assembly using the foam in place pouring process to mute or dampen vibrations at areas subject to resonance. Accordingly, the lower mold part 62 of the mold 58 may be modified to include additional channels 94, in fluid communication with or independent of the beam forming recesses, that are filled during the molding operation at workstation 38. These produce a foam pad mounted at selected locations to the headliner providing acoustic control or protecting against buzzes, squeaks and rattles as shown at 96 as predetermined to be desired. The pads may be secured to a main body 12 or other components of the headliner. Alternatively, the noise reduction or audio control pads may also be formed in recesses in fluid communication with channels for forming the foam beam so that continuous pouring during displacement of the pour heads 74 can speed the process of pouring foam into the beam forming channels. Preferably, as shown in the preferred embodiment of FIG. 7, the noise reduction pads are made from an acoustically absorbent foam, and may be smaller, thinner and thus less bulky than other portions of the structural beams, particularly when formed adjacent to, or within a peripheral frame formed by foam beams.

When the headliner assembly 10 is transferred to the cutting station 40, which is shown in FIG. 4, a computer controlled, water jet cutting device 80 trims the headliner assembly 10. Trimming may include cutting openings through the headliner assembly 10, for example, within the component area 86 or for communication or access to the couplers or terminals of the embedded cable 33 or tube 100. The rigidity and dimensional stability is preferably closely matched to the final size or outline of the headliner assembly 10 so that the amount of trimming required is significantly reduced compared with prior methods of forming headliners. The headliner assembly 10 is then transferred to the fixture assembly station 42 where installation of such fixtures as coat hooks, dome lights, wire couplings and ornaments is completed. The headliner blank may also be trimmed before molding and foam introduction, particularly when couplings may be protected within the headliner or in a part cavity that may or may not recess foam during molding.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for forming a headliner comprising:
forming a main body by shaping a substrate blank;
pouring foam in a lower mold part having at least one mold surface conforming to said shaping and having a recess;
positioning said blank over said lower mold part;
closing the blank against the at least one mold surface; and
joining foam in said recess to said blank by curing said foam during or after said closing.

2. The invention as described in claim 1 wherein said positioning comprises enclosing a component secured on said blank within said recess.

3. The invention as described in claim 1 and further comprising inserting a component in a position area in said recess before said pouring step.

4. The invention as described in claim 1 wherein said positioning comprises aligning said blank with respect to upper mold part.

5. The invention as described in claim 4 wherein said aligning step processes said pouring step.

6. A method for forming a headliner comprising:
forming a main body by shaping a substrate blank;
pouring foam in a lower mold part having at least one mold surface conforming to said shaping and having a recess;
positioning said blank over said at least one mold surface;
inserting a component in alignment with at least a portion of said recess to one of said substrate and a surface of said mold recess;
closing the at least one mold surface against said blank; and
joining said foam and said component to said blank by curing said foam.

7. The invention as described in claim 6 wherein said applying a component includes aligning said component in a predetermined location in said recess.

8. The invention as described in claim 7 wherein said location includes alignment devices and aligning comprises engaging said component with said alignment devices.

9. The invention as described in claim 6 wherein said component is an electrical conductor.

10. The invention as described in claim 6 wherein said component is a fluid conductor.

11. The invention as claimed in claim 6 wherein said component is an impact energy absorbing member.

12. The invention as described in claim 6 wherein said inserting comprises attaching said component to said substrate before said positioning.

13. The invention as described in claim 6 and further comprising inserting a mold release layer over said lower mold part before said pouring step.

14. A method for forming a headliner comprising:
forming a main body by shaping a substrate blank;
attaching at least one component to said main body;
filling a recess in at least one open mold surface with foam;
positioning said blank over said at least one open mold surface and conforming to said shaping with said recess aligned with said component; and
closing the at least one mold surface against said blank to join said foam to said blank and embedding said component in said foam.
